(19) United States
(12) Patent Application Publication
(10) Pub. No.: US 2026/0072207 A1
(43) Pub. Date: Mar. 12, 2026

(54) LIGHTGUIDE OPTICAL ELEMENTS HAVING OBLIQUE EMBEDDED RETARDERS OR JOINTS AND CORRESPONDING METHODS OF MANUFACTURE

(71) Applicant: LUMUS LTD., Ness Ziona (IL)

(72) Inventors: Edgar FRIEDMANN, Sdey-Avraham (IL); Yochay DANZIGER, Kfar Vradim (IL); Ronen CHRIKI, Lod (IL); Elad SHARLIN, Mishmar David (IL); Eitan RONEN, Rechovot (IL); Avishai MARSON, Ness Ziona (IL); Amir SHAPIRA, Ness Ziona (IL); Tsion EISENFELD, Ashkelon (IL); Itay DYAMANT, Ness Ziona (IL)

(21) Appl. No.: 19/131,063

(22) PCT Filed: May 23, 2024
(86) PCT No.: PCT/IL2024/050513

§ 371 Date: May 19, 2025

Related U.S. Application Data
(60) Provisional application No. 63/468,687, filed on May 24, 2023.
(60) Provisional application No. 63/534,205, filed on Aug. 23, 2023.
(60) Provisional application No. 63/535,105, filed on Aug. 29, 2023.
(60) Provisional application No. 63/609,365, filed on Dec. 13, 2023.

(51) Int. Cl. F21V 8/00

(52) U.S. Cl. CPC G02B 6/0065; G02B 6/0088

(57) ABSTRACT

A method for manufacturing lightguide optical elements (LOEs) having an embedded retarder inclined at an oblique angle includes forming a first stack (560) of a plurality of planar retarder elements interspaced with, and bonded to, a plurality of transparent plates (562). This first stack is then sliced along slicing planes (566) obliquely angled to the retarder elements to form a tilted retarder plate (569) containing obliquely angled portions (570) of the retarder elements. The tilted retarder plate (569) is then combined into a second stack (571) bonded between a first precursor block (572) and a second precursor block (574). This second stack is then sliced along slicing planes (578) to form LOEs (510) each containing an obliquely angled embedded retarder (526).

### FIELD AND BACKGROUND OF THE INVENTION

The present invention relates to displays and manufacturing methods therefor. In particular, it concerns lightguide optical elements having oblique embedded retarders or joints and corresponding methods of manufacture.

There is a growing demand for head mount displays (HMD) that provide large fields of view implemented as light and compact eyewear. Often, such structures consist of several refractive or diffractive elements that are embedded in a slab lightguide. One of the known problems that occurs in such systems is a loss of efficiency due to polarization mismatch between the different elements. Another issue which may be problematic is the formation of ghost images resulting from unwanted reflections from certain embedded elements.

### SUMMARY OF THE INVENTION

The present invention relates to methods of manufacture of lightguide optical elements (LOEs).

According to the teachings of an embodiment of the present invention there is provided, a method for manufacturing lightguide optical elements (LOEs) having an embedded retarder inclined at an oblique angle, the method comprising the steps of: (a) forming a first stack of a plurality of planar retarder elements interspaced with, and bonded to, a plurality of transparent plates; (b) slicing the first stack along a plurality of parallel slicing planes obliquely angled to the planar retarder elements to form at least one tilted retarder plate having a pair of major parallel surfaces and containing portions of a plurality of the planar retarder elements obliquely angled to the major parallel surfaces; (c) forming a second stack comprising the tilted retarder plate interposed between, and bonded to, a first precursor block and a second precursor block; and (d) slicing the second stack along a plurality of parallel slicing planes to form a plurality of LOEs each containing part of the tilted retarder plate, thereby providing an obliquely angled embedded retarder in each of the LOEs.

According to a further feature of an embodiment of the present invention, the slicing planes of the second stack are aligned with the portions of the planar retarder elements so that each of the LOEs contains part of only one of the planar retarder elements.

According to a further feature of an embodiment of the present invention, the slicing planes of the second stack are aligned with the portions of the planar retarder elements so that at least two of the LOEs contain parts of one of the planar retarder elements.

According to a further feature of an embodiment of the present invention, the first precursor block comprises a plurality of partially reflecting planar internal surfaces at a first orientation non-parallel to the planar retarder elements and the second precursor block comprises a plurality of partially reflecting planar internal surfaces at a second orientation non-parallel to both the planar retarder elements and the first orientation.

According to a further feature of an embodiment of the present invention, the first precursor block comprises a plurality of LOE precursor portions temporarily bonded together at bonding planes to form a block, and wherein the slicing of the second stack is performed along the bonding planes.

There is also provided according to the teachings of an embodiment of the present invention, a method for manufacturing lightguide optical elements (LOEs) having a first region and a second region bonded at an obliquely angled interface plane, the method comprising the steps of: (a) forming a first stack of a plurality of LOE first region precursor plates, each precursor plate having two mutually parallel major surfaces, each precursor plates being temporarily bonded together at adjacent major surfaces to form bonding planes; (b) processing the first stack to form a smooth edge surface at an oblique angle to the major surfaces; (c) processing a complementary block having outer surfaces to form a smooth edge surface at the oblique angle to the outer surfaces; (d) bonding the smooth edge surface of the first stack to the smooth edge surface of the complementary block at an interface plane to form a composite block; and (e) parting the composite block along planes corresponding to the bonding planes to generate a plurality of LOEs having a first region and a second region bonded at an obliquely angled interface plane.

According to a further feature of an embodiment of the present invention, the first region precursor plates are temporarily bonded together in a stepped configuration with an offset between successive precursor plates, the stepped configuration approximating to the oblique angle.

According to a further feature of an embodiment of the present invention, the bonding includes integrating a retarder plate at the interface plane.

According to a further feature of an embodiment of the present invention, the complementary block is a second stack of a plurality of LOE second region precursor plates, each precursor plate having two mutually parallel major surfaces, the precursor plates being temporarily bonded together at adjacent major surfaces to form bonding planes.

According to a further feature of an embodiment of the present invention, the complementary block is a unitary block of transparent material.

According to a further feature of an embodiment of the present invention, the first stack and the complementary block are each further processed to generate a second smooth edge surface at a second oblique angle, the method further comprising the steps of: (a) processing a second complementary block having outer surfaces to form a smooth edge surface at the second oblique angle to the outer surfaces; (b) bonding the second smooth edge surfaces of the first stack and the complementary block to the smooth edge surface of the second complementary block at a second interface plane to form the composite block prior to the parting.

### BRIEF DESCRIPTION OF THE DRAWINGS

The invention is herein described, by way of example only, with reference to the accompanying drawings, wherein:

FIGS. 1A and 1B are schematic isometric views of two variants of a display device employing lightguide optical elements (LOEs) according to the teachings of the present invention;

FIG. 2A is a schematic isometric view illustrating the optical functionality of the LOE from FIGS. 1A and 1B;

FIG. 2B is a view similar to FIG. 2A illustrating the function of an embedded retarder element within the LOE;

FIG. 3 is a schematic side view illustrating various light ray paths from external scenery through the retarder element of the LOE;

FIG. 4 is a schematic side view illustrating a two-component retarder element in the LOE;

FIG. 5A is a schematic front view of an LOE from FIGS. 1B and 2B illustrating the light path of image light from a projector through the LOE to the eye of an observer;

FIGS. 5B and 5C top views of the LOE of FIG. 5A illustrating a change in polarization occurring at a retarder element for two incident beams;

FIG. 6A is a schematic view similar to FIGS. 5A and 5B illustrating a light path of a real-world ghost image reflected from the retarder element;

FIGS. 6B and 6C are views similar to FIG. 6A illustrating the contribution of various oblique tilt angles of the retarder element in preventing real-world ghost images from reaching the eye of the observer;

FIGS. 7A and 7B are views similar to FIGS. 5B and 5C illustrating the impact of retarder element inclination on the light paths through the retarder element;

FIG. 7C is a graph illustrating schematically the impact of variations of incident angle relative to the retarder element on efficiency of the optical system;

FIGS. 8A-8F are a sequence of schematic isometric views illustrating stages in a stack-based manufacturing method for producing LOEs with obliquely angled embedded retarder elements according to an aspect of the present invention;

FIG. 9A is a schematic isometric view of a variant implementation of the method of FIGS. 8A-8F showing a stack similar to FIG. 8D where each embedded retarder element spans multiple LOE thicknesses;

FIG. 9B is a side view of the stack of FIG. 9A after slicing;

FIG. 10A is a schematic front view of another LOE according to an aspect of the present invention for use in the display device of FIG. 1B;

FIG. 10B is a view similar to FIG. 10A showing the LOE subdivided into multiple segments for manufacture;

FIGS. 11A-11E are a sequence of front views illustrating a process of assembly for the LOE of FIG. 10B;

FIG. 12A is a partial top view of the LOE of FIG. 10B illustrating how perpendicular interfaces between the various segments may give rise to real-world ghosts visible to the user;

FIG. 12B is a view similar to FIG. 12A illustrating that an oblique inclination of the interface planes may be used to ameliorate the real-world ghosts of FIG. 12A;

FIGS. 13A and 13B are schematic side views and a front view, respectively, illustrating light paths which may generate image ghosts from a perpendicular interface plane;

FIGS. 13C and 13D are views similar to FIGS. 13A and 13B, respectively, illustrating that an oblique inclination of the interface planes may be used to ameliorate the image ghosts of FIG. 13B;

FIGS. 14A and 14B illustrate stages in a batch manufacturing process to prepare LOE precursor segments with a desired oblique interface surface;

FIGS. 15A and 15B illustrate stages in a batch manufacturing process allowing bonding of multiple LOE precursor segments;

FIGS. 16A-16G are a sequence of schematic isometric views illustrating the batch manufacturing process of FIGS. 15A and 15B expanded to three dimensions and used to combine multiple stacks of LOE precursor segments to form LOEs such as that of FIG. 10B;

FIGS. 17 and 17B are views similar to FIGS. 16D and 16E, respectively, illustrating an implementation of the batch manufacturing process in which the precursors of the clear transparent segments of the LOE are provided as continuous blocks of transparent material; and

FIG. 18 is a view similar to FIG. 10B illustrating an alterative subdivision of the LOE of FIG. 10A into segments for manufacture.

### DESCRIPTION OF THE PREFERRED EMBODIMENTS

The present invention provides lightguide optical elements (LOEs) having oblique embedded retarders or joints and corresponding methods of manufacture.

The principles and operation of lightguide optical elements and corresponding methods of manufacture according to the present invention may be better understood with reference to the drawings and the accompanying description.

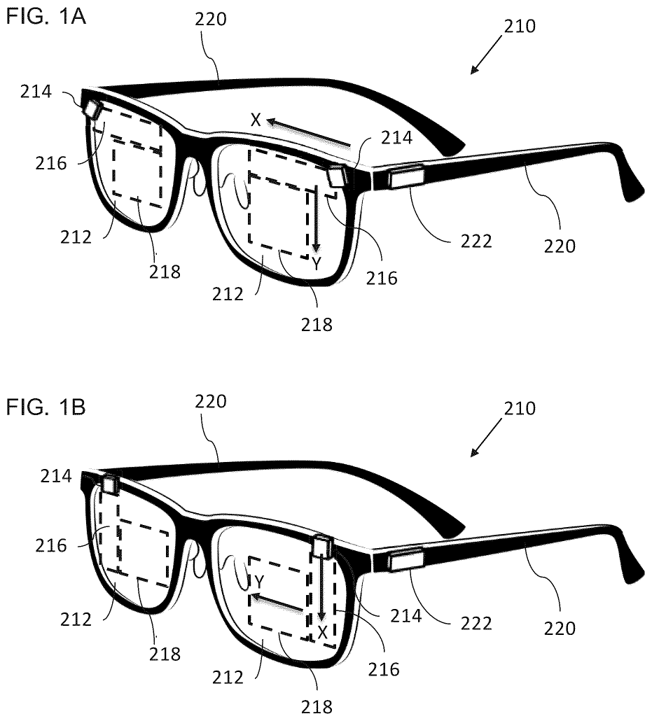

Referring now to the drawings, FIGS. 1A and 1B illustrate a typical usage scenario of LOEs of the present invention.

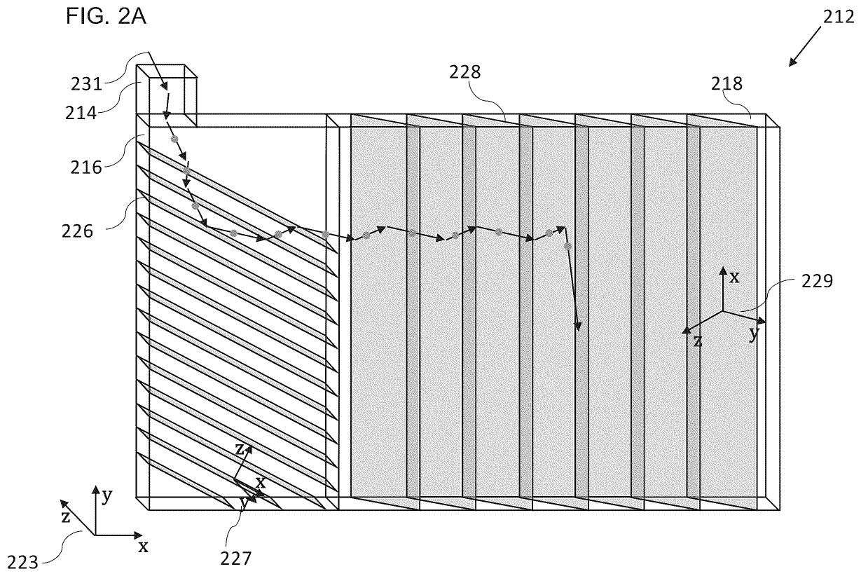

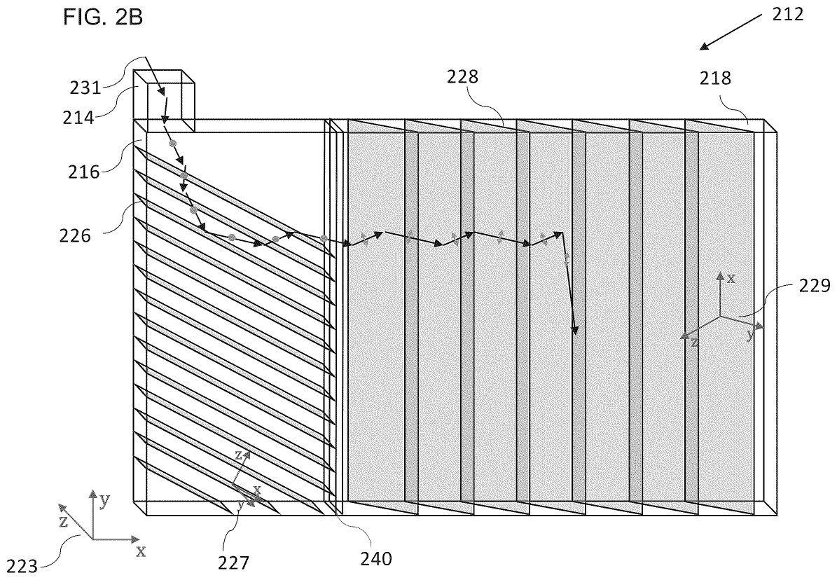

These drawings show an exemplary display device 210 employing a lightguide optical element 212 to provide two-dimensional optical aperture expansion. A projector 214 injects an input image into LOE 212, where light is trapped by total internal reflection (TIR) between two parallel major surfaces. The image propagates inside the lightguide until it interacts with embedded elements that lie in a first lightguide region 216 and is redirected to a new direction that is also trapped by the two parallel major surfaces by TIR. The image then propagates in the new direction until it interacts with a second set of embedded elements that lie in a second lightguide region 218, which redirect the light and couple the image out of the lightguide and into an “eye motion box,” in which it is assumed the eye of the user will be located. FIGS. 1A and 1B are similar, but illustrate that the two-dimensional aperture expansion may be performed as a first dimension X in the horizontal direction followed by a second dimension Y vertically, as shown in FIG. 1A, or the reverse, as shown in FIG. 1B. The embedded elements may be made of surface or volume gratings, or from partially reflective mirrors, as presented in FIGS. 2A and 2B, below.

In the non-limiting case of a head-mounted display (HMD), display device 210 also includes a support arrangement for supporting the display elements in facing relation to the user's eyes, in this case shown as a glasses frame form factor with support elements 220 for supporting the device in relation to the user's ears and on the nose. Other components, including electronic driver circuitry, data storage, communications components and a power supply may be located onboard, as represented schematically at 222 and/or may be provided via a wired or wireless link (not shown) to an external device. These other components are known in the art and will not be discussed here further.

FIGS. 2A and 2B illustrate schematically the optical function of first lightguide region 216 and second lightguide region 218 in a case of embedded partially reflecting surfaces 226 and 228, respectively. In FIG. 2A, an input ray 231 is coupled into the lightguide with an initial polarization. As illustrated here simplistically, the initial polarization is maintained throughout the entire lightguide. The input polarization is typically selected to match a linear polarization state in the polarization basis of the major surfaces (set of axes 223), namely it would often be selected to be p-polarized or s-polarized as compared to the orientation of the two major surfaces. However, light that is p-polarized (or s-polarized) in relation to the major surfaces of the lightguide does not generally have the same polarization in relation to the partially reflective co parallel surfaces 226 (set of axes 227) or surface 228 (set of axes 229), due to the different orientations of 226, 228 and the major surfaces. This causes a natural polarization mismatch between the different elements, often reducing the output efficiency of the HMD.

To address this issue, FIG. 2B shows an embedded retarder 240 that is embedded in the lightguide. The retarder rotates the polarization and allows better polarization matching between elements 226 and 228, as shown in the figure. This is similar to the configuration discussed in FIG. 4 of PCT publication no. WO 2022/175934.

Retarder elements can be made from various materials, for instance, of birefringent crystalline materials. Since it is typically required to rotate the polarization of a large frequency spectrum (visible light), and the lightguide is meant to support a relatively large field of view, it is often advantageous to work with a true zero order waveplate, namely, a waveplate with thickness d given by:

$$d ∼ \frac{{λ}_{0}}{2 cos {θ}_{0} ( {n}_{o} - {n}_{e} )}$$

where λ₀ is the central wavelength or the dominant peak wavelength, θ₀ is the incident angle of the central field on the retarder element, and no and ne are the ordinary and extraordinary refractive indices of the birefringent material.

Various artifacts may occur if the birefringent material is made of made of material having refractive indices significantly different from that of the substrate material of the lightguide.

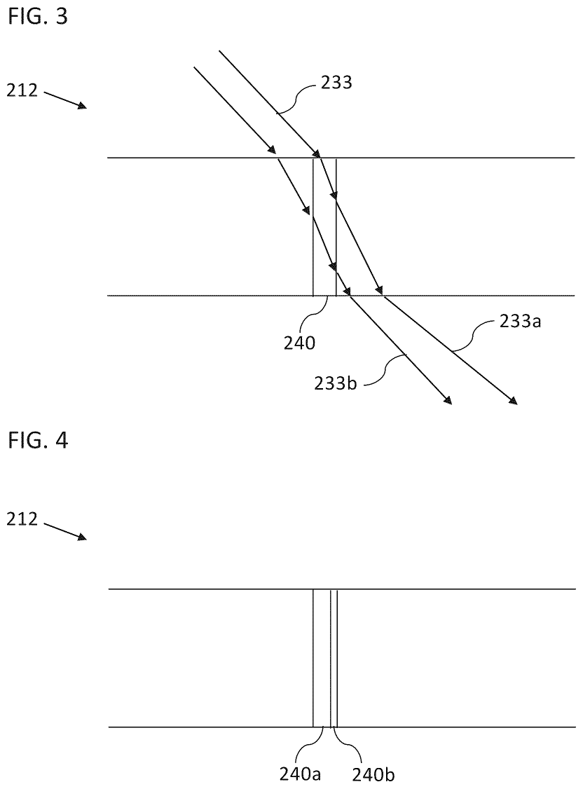

One effect that may occur due to a difference in refractive index between the lightguide substrate and the retarder is a ghost image of the world scenery, as shown in FIG. 3. Incident light rays 233 will be deflected to rays 233a if they are transmitted through the front or back edge of the retarder, compared to rays 233b if they pass through the thickness of the retarder and emerge parallel to the incident rays. Since the thickness of the retarder is relatively small, and the angular regime in which the ghost exists is limited, this effect is often negligible.

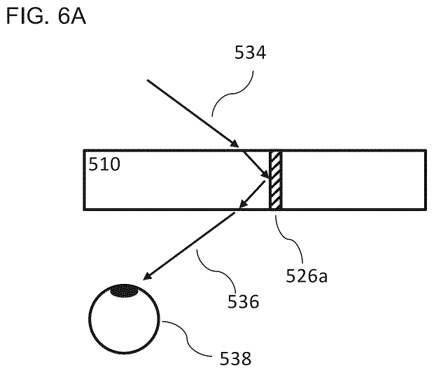

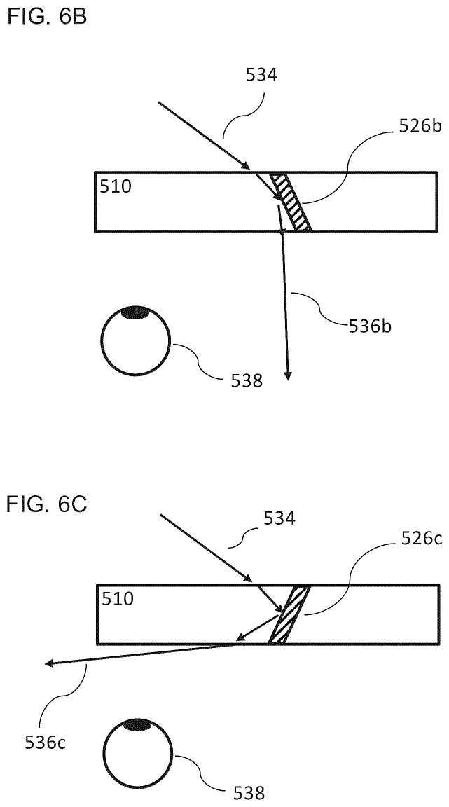

A further effect that may occur due to a difference in refractive index between the lightguide substrate and the retarder is a ghost image of the world scenery, as will be discussed below with reference to FIG. 6A. If the effective refractive index of the retarder (considering the polarization state of the incoming ray 235) is lower than the refractive index of the lightguide substrate, the ray will be reflected by the retarder due to TIR, and a strong ghost may be observed by the user. Moreover, this effect enhances the conspicuity of the lightguide, detrimentally affecting its cosmetic appearance to a viewer.

To reduce this effect, it is advantageous to select a retarder with refractive index that is close to that of the substrate, and slightly higher than the substrate. If the lightguide substrate is made of BK7 glass, for example, it may be advantageous to work with Crystaline Quartz for the retarder. However, if higher refractive index substrate glasses are used for the lightguide, it may be preferred to use higher index birefringent materials for the retarder, such as Calcite, Lithium Niobate, Crystaline Sapphire, Mica or KTP. While these are preferred embodiments, other high refractive index crystalline materials may also be envisaged, as well as meta-materials or meta-surfaces.

Since HMDs typically employ light sources that cover the entire visible spectrum, the retarder should approximate to a uniform polarization rotation (conversion) efficiency as a function of wavelength. To minimize dispersion artifacts of the retarder and obtain such uniform conversion efficiency, FIG. 4 shows another embodiment of this invention, in which the retarder is made by combining two or more birefringent materials 240a and 240b. By choosing suitable combinations of materials, the dispersion properties of the retarder can be better tailored to improve the spectral performance of the retarder. Using suitable combinations of materials for the retarder may also help improve the angular sensitivity of the retarder and obtain a retarder with nearly uniform polarization rotation efficiency as a function of incident angle.

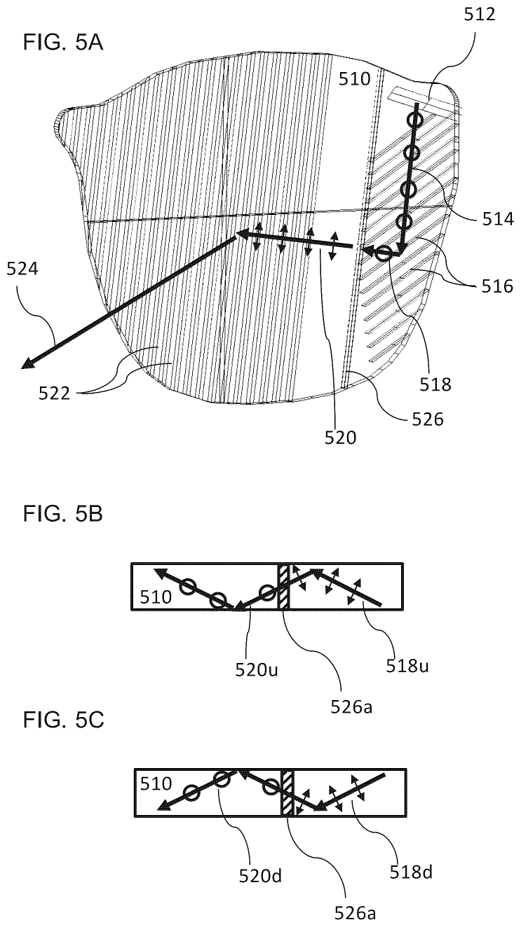

A further example of an LOE 510 according to an aspect of the present invention is illustrated in FIG. 5A. As above, the lightguide 510 performs vertical and lateral aperture expansion for a near eye display. A projector having a small aperture (not shown) injects collimated image light through a coupling—in configuration, such as a prism 512, into the lightguide to be guided by total internal reflection. One beam is shown schematically as arrow 514. The polarization of the beam is preferably with its electric vector perpendicular to the major surfaces of the lightguide (shown as circles).

Embedded elements, here in the form of a first set of parallel partial reflectors 516, are embedded in lightguide 510 and oriented perpendicular to the external planes of the lightguide. This set of partial reflectors progressively reflect the incident beam redirecting it horizontally, thereby vertically multiplying the incident aperture. One such beam is shown as an arrow 520.

The beam 520 continues to propagate in the lightguide and impinges on a second set of parallel partial reflectors 522 that are obliquely angled and progressively reflect the light, coupling it out of the lightguide as beam 524. The progressive reflection by this second set of embedded elements generates lateral aperture multiplication.

Both sets of embedded elements 516 and 522 partially reflect primarily S-polarized light and mostly transmit P-polarized light, where the polarization is defined relative to the orientation of the embedded element surface. Because of the relative orientation of the two sets of embedded elements, light that is S-polarized relative to embedded elements 516 will be P-polarized relative to embedded elements 522. Therefore, a half-wave retarder 526 is placed in the lightguide between the two sets of embedded elements.

The reflected beam 518 that is P-polarized (relative to lightguide planes) passes through half wave retarder 526 and emerges as S-polarized (marked as double arrows) as it impinges on embedded elements 522 thereby being reflected efficiently.

FIGS. 5B and 5C show side views of the interface with the retarder, implemented here as an upright retarder 526a. The initially-upward beams 518u (labeled in FIG. 5B) and the initially downward beams 518d (labeled in FIG. 5C) coexist in lightguide 510 and are shown separately for clarity. These beams interchange at each reflection from the top or bottom surface of the lightguide. Both beams impinge on upright retarder 526a (corresponding to an implementation of retarder 526 in FIG. 5A) and change polarization. In this side view, the markings on the polarization (circle and double arrows are exchanged because of different presentation orientation). The emerging beams 520u and 520d (that also co-exist and interchange) have orthogonal polarization relative to 518u and 518d.

FIG. 6A shows scenery light 534 entering lightguide 510 and impinging on retarder 526a. This retarder has a refractive index that is different from that of lightguide 510. This results in light 536 being reflected towards the observer's eye 538. This reflection may be strong in the case of total internal reflection, or lower in intensity if Fresnel reflection is the main mechanism, although even Fresnel reflection may be troublesome in the case of a strong light source, such as direct sunlight.

FIG. 6B shows that it is possible to implement retarder 526 of FIG. 5A as waveplate 526b in a tilted orientation. Scenery light 534 is then reflected as 536b at a different angle that is outside the eye-box and does not reach the observer's eye 538.

FIG. 6C shows an alternative in which retarder 526 of FIG. 5A is implemented as waveplate 526c with an oppositely tilted angle, thereby reflecting scenery light beam 534 as reflected beam 536c, which is also outside the eye-box, such that the observer will not see the scenery light from this specific orientation.

The choice between the architectures of FIGS. 6B and 6C depends on the specific location of the eye-box relative to the lightguide and the waveplate. The expected entry angles of bright scenery light must also be considered.

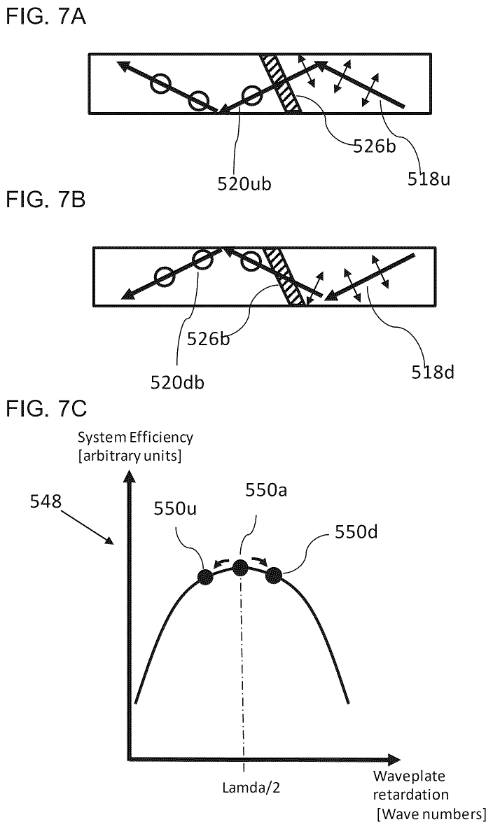

Another consideration when using a tilted waveplate, such as retarder 526b, is shown in FIGS. 7A and 7B. FIGS. 7A and 7B show the interaction of tilted waveplate 526b with beams 518u and 518d (equivalent to the beams illustrated in FIGS. 5B and 5C, above). Because of the waveplate tilt, the retardation that these beams experience will be different, so that beams 520ub and 520bd exiting from the retarder will not have the same optimal retardation as beams 520u and 520b of FIGS. 5B and 5C.

FIG. 7C shows system efficiency as a function of retardation by waveplate 526b. The thickness of 526b is set to that of optimal retardation of 2/2 (550a) which is achieved for beams incident at the angles of 520u and 520d in FIGS. 5B and 5C, thereby changing s-polarization to p-polarization (and vice versa).

As beam 518u impinges on tilted waveplate 526b closer to perpendicular, it has a shorter optical path through waveplate 526b and therefore undergoes less retardation, corresponding to point 550u in FIG. 7C. Conversely, beam 518d traverses a longer distance through the retarder and therefore undergoes more retardation, corresponding to point 550d. Both deviations (550u and 550d) from optimal (550a) should be small so that system efficiency will not be degraded below a satisfactory level. Since (by definition) system efficiency graph near optimum 550a is a maximum with zero slope and the variation with retarder thickness depends on the cosine of the incident angle deviation from the optimal design angle (i.e., from the angles of FIGS. 5B and 5C), a range of tilt angles can be achieved with minimal impact on system performance. Nevertheless, this degradation limits the angle implemented on the waveplate to prevent reflections from entering the eye-box.

Another consideration when tilting the waveplate is that rays that propagate through the boundaries of the retarder will be deflected angularly, and will therefore contribute to a ghost image, as illustrated in FIG. 3, above. If the retarder is sufficiently thin, the effect will be small and the ghost will be negligible. It is therefore often preferable to use materials with high birefringence (i.e. large difference between the different components of refractive index), such as Calcite or Lithium Niobate (LiNbO₃).

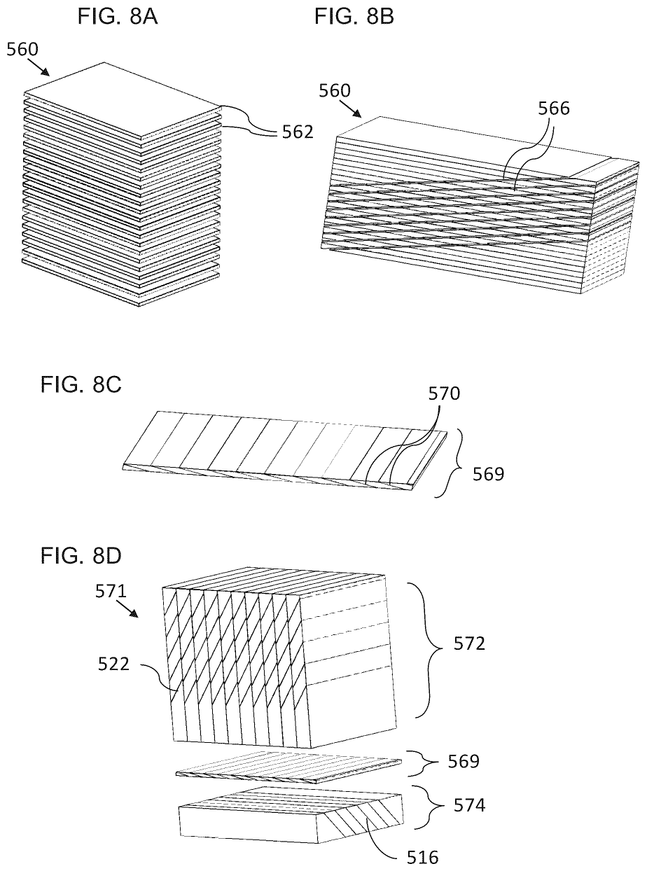

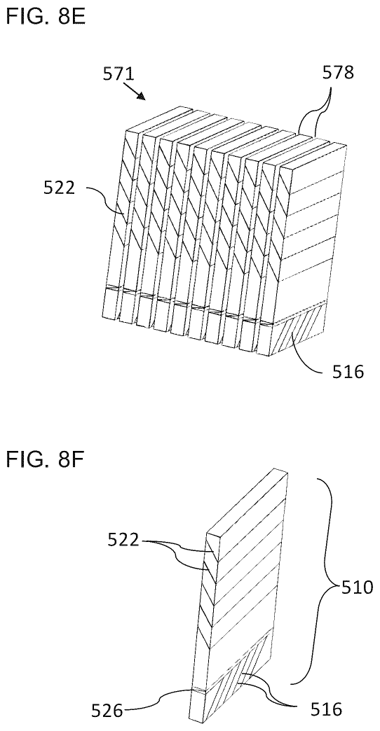

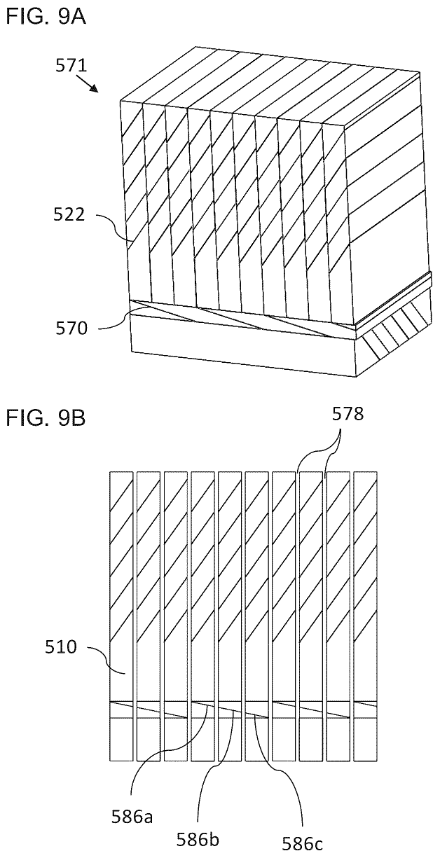

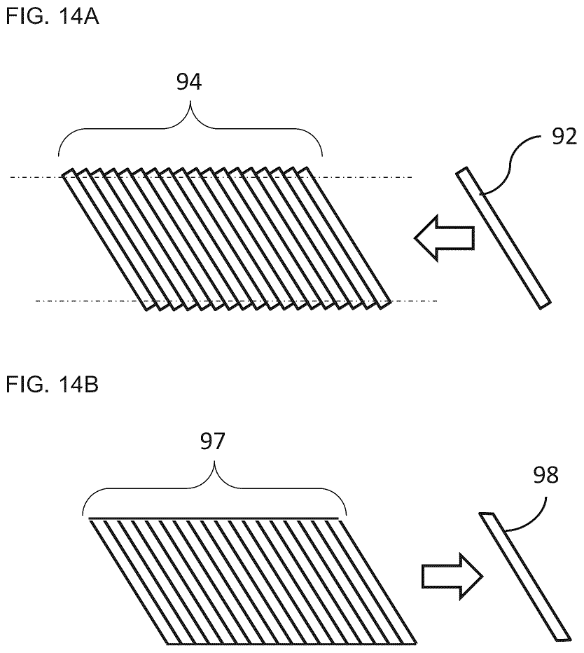

Further aspects of the present invention relate to methods for manufacturing lightguide optical elements with obliquely angled embedded retarders. In most cases, the preferred orientation of the embedded retarder is not parallel to any of the other embedded partial reflectors, which renders manufacture non-trivial. One particularly preferred approach to manufacturing such structures is presented here with reference to FIGS. 8A-9B. An alternative preferred approach for manufacturing LOEs with obliquely oriented joints and/or retarders will be discussed below with reference to FIGS. 14A-18.

Turning now to FIGS. 8A-9B, these drawings illustrate stages of a method for manufacturing lightguide optical elements (LOEs) having an embedded retarder inclined at an oblique angle. This begins in FIG. 8A with forming a first stack 560 of a plurality of planar retarder elements interspaced with, and bonded to, a plurality of transparent plates 562. Practically, the retarder elements are typically formed as a thin layer on each plate 562, which serves as a carrier for the retarder element, and the stack is formed by bonding a pile of such plates.

First stack 560 is then sliced along a plurality of parallel slicing planes 566 obliquely angled to the planar retarder elements, as shown in FIG. 8B, to form at least one tilted retarder plate 569 (FIG. 8C) having a pair of major parallel surfaces and containing portions 570 of a plurality of the planar retarder elements obliquely angled to the major parallel surfaces.

The tilted retarder plate 569 is then combined into a second stack 571 formed by interposing the tilted retarder plate between, and bonding it to, a first precursor block 572 and a second precursor block 574 (FIG. 8D).

The second stack 571 is then sliced along a plurality of parallel slicing planes 578 as shown in FIG. 8E to form a plurality of LOEs 510 (FIG. 8F) each containing part of the tilted retarder plate, thereby providing an obliquely angled embedded retarder 526 in each of the LOEs.

In the case of an LOE employing sets of embedded partially reflecting surfaces such as was described above with reference to FIGS. 2B and 5A, first precursor block 572 includes a plurality of partially reflecting planar internal surfaces 522 at a first orientation non-parallel to the planar retarder elements and second precursor block 574 includes a plurality of partially reflecting planar internal surfaces 516 at a second orientation non-parallel to both the planar retarder elements and the first orientation, all as seen in FIG. 8D.

In certain cases, as shown in FIG. 8D, the design requirements for one or both of the precursor blocks may favor manufacturing a plurality of LOE precursor portions, each with its own embedded partial reflectors, and then temporarily bonding together those LOE precursor portions at bonding planes to form the precursor block. As seen in FIG. 8D, in this example, this is the case for first precursor block 572, as visible from the vertical lines subdividing the block, and from the fact that some of the partially reflecting internal surfaces 522 are discontinuous between adjacent LOE precursor portions. Second precursor block 574, on the other hand, is here formed as a single block cut from a corresponding stack of plates.

Where one or both of the precursor blocks is formed from an assembly of LOE precursor portions, slicing of the second stack is preferably performed along the bonding planes, as shown in FIG. 8E.

Wherever a process of slicing is described herein, the resulting slice is preferably then polished, typically by a double-sided polishing process, to generate high quality optical surfaces prior to the subsequent steps.

It is preferable for the slicing planes of the second stack to be aligned with the portions of the planar retarder elements so that each LOE contains part of only one of the planar retarder elements. This avoids there being a step in the retarder, and thus helps to ensure that all of the light propagating within the LOE passes through the retarder. In the example of FIGS. 8E and 8F, the slicing planes for each LOE line up with the edges of a single planar retarder element portion 570, with a one-to-one relationship between the LOE slices and the strips of planar retarder element portions 570.

FIGS. 9A and 9B illustrate the second stack, before and after slicing, according to a variant implementation in which each element portion 570 spans the thickness of multiple LOEs. The slicing planes of the second stack are then aligned with the portions of the planar retarder elements 570 so that at least two, and in this case three, of the LOEs contain parts 586a, 586b, 586c of one of the planar retarder elements. In this case, the position of the retarder elements is slightly shifted between the different LOEs, but the functionality is unaffected. This approach allows the use of thicker tilted retarder plates 569, thereby reducing the number of cutting operations which are required on planes 566 of FIG. 8B.

Turning now to FIGS. 10A-18, these illustrate further aspects of the present invention relating to LOEs constructed from a number of different sections and, in certain cases, also provide solutions for embedding obliquely inclined retarder elements.

FIG. 10A shows a front view of a lightguide optical element (LOE) 20 with a schematically represented projector 5 introducing a collimated image into the LOE. As in the previous examples, the LOE has two active areas, here labeled E and A, which perform two stages of optical aperture expansion, with area E progressively redirecting the image light towards area A, and area A progressively redirecting the image light outwards toward the eye of the viewer. Areas E and A may contain either sets of embedded partially reflecting surfaces as described above or may be implemented using diffractive optical elements, such as surface gratings or volume gratings. The in-plane components of exemplary light propagation paths are illustrated by arrows, each representing rays which are propagating by internal reflection from the front and back surfaces of the LOE. More complex configurations with additional active areas, and various combinations of reflective and diffractive components, may be used.

FIG. 10B shows an example of sectioning the blank area of the lightguide so it may be produced cost effectively. This approach takes into consideration that active sections A and E are the most expensive to produce therefore their area should be minimal as required by optical functionality. It is also typically preferable to omit the active (diffractive or reflective) elements from regions in which they are not needed for conveying the image to the eye so as to optimize efficiency and minimize the chances of unwanted ghost image generation. Other sectioning can be designed with some compromise on area and processing steps.

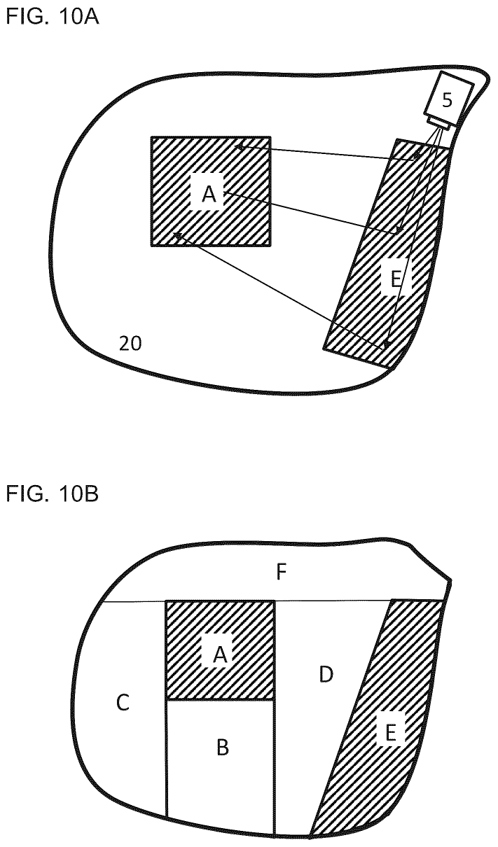

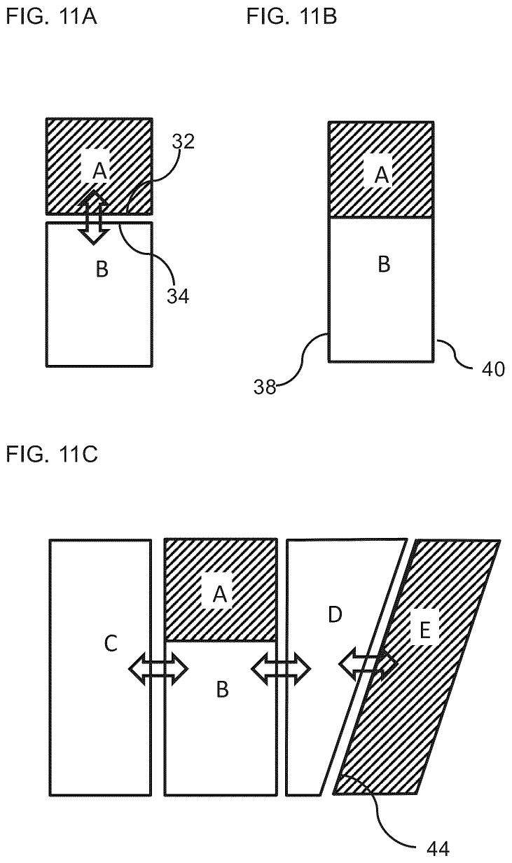

FIGS. 11A-11E illustrate a possible sequence of integration of lightguide segments to assemble the LOE of FIG. 10B. In FIG. 11A, Section A (incorporating internal partial reflectors or diffractive elements) is cut to the approximate required size from a plate. The process of producing this plate is not described here but is known in the art according to the various technologies mentioned above. One edge 32 of section A is processed to be flat (either optically flat or diffusive). Preferably, this processing is performed on a stack of plates simultaneously (as described below) so as to reduce manufacturing costs. Blank plate B is cut to approximate size and with one face 34 processed to be flat. (This processing of the surfaces is done at each of the interfaces between segments described below, but for conciseness, will not be mentioned hereafter.) Sections A and B are attached at planes 32 and 34, typically by index matched optical adhesive, while maintaining approximate parallelism and coplanarity of front and back planes of the sections.

In FIG. 11B, both edges 38 and 40 are processed (polished or grinded) to be flat and continuous. This is preferably done simultaneously by double side polish to achieve accuracy and reduce cost.

In FIG. 11C, blank sections C and D are attached to A+B and to E (polished or grind on plane 44). Preferably this attachment with index-matched-glue is performed simultaneously to minimize integration steps.

In FIG. 11D, the top surface 48 of combined sections A, B, C, D and E is processed to be flat and is attached to blank section F. The combined sections are now double-side optically polished (front and back surfaces) to generate smooth surfaces. Finally, as shown in FIG. 11E, the combined sections are trimmed along line 52 to generate the lightguide shown in FIG. 10A. The order of the last two steps (polishing and trimming) may be reversed.

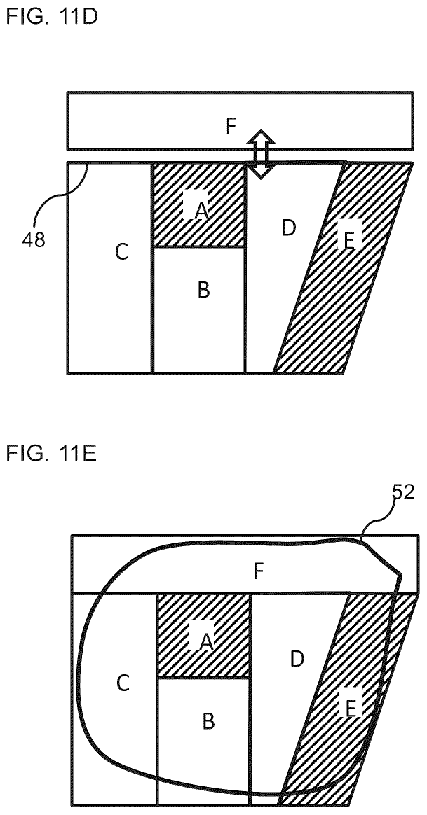

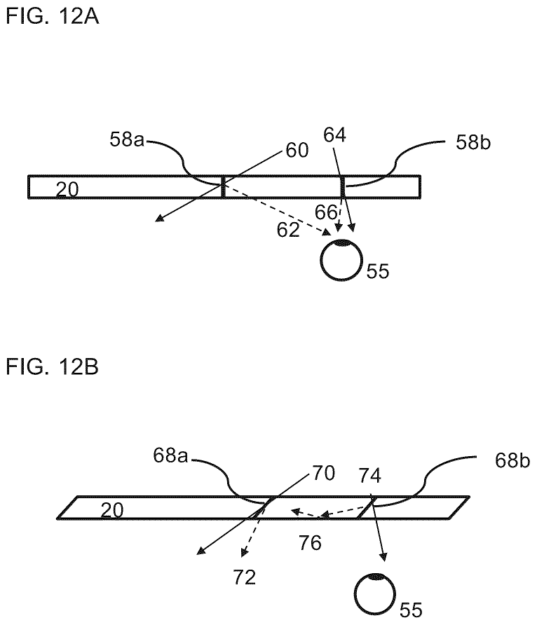

20) Although the subdivision of the LOE into segments is highly advantageous, problems may arise due to ghost reflections from the interfaces between these segments. The glue used for the interfaces is never perfectly matched in refractive index to the segments themselves. Consequently, light impinging on these interfaces could reflect toward the observer and generate undesired reflections (ghost) especially if the reflection is at grazing angles relative to the interface plane. FIGS. 12A and 12B illustrate this problem, and how a slanted interface can prevent such ghost 25 reflections from scenery from reaching the eye 55 of the viewer.

In FIG. 12A, lightguide 20 has perpendicular segment interfaces 58a and 58b. Beam 60 from scenery impinges on interface 58a at large angle and therefore a low intensity yet likely observable ghost beam 62 reflects towards the eye 55. A beam 64 grazing to interface 58b will generate a high intensity ghost beam 66 toward the eye.

In FIG. 12B, the interfaces 68a and 68b are slanted at a predefined angle that reflects light away from the eye as shown by beams 70 and 74. Beam 70 impinges on interface 68a at grazing angle, therefore generating a high intensity ghost, but this ghost reflects in a direction away from the eye 55. Beam 74 traverses interface 68b at a different angle but here the reflected ghost is coupled to propagate within the lightguide away from the eye 55. Thus, the angle of interfaces between the sections can be set for each interface relative to the eye-box position so that ghosts generated by scenery light beams will be diverted away from the observer's eye.

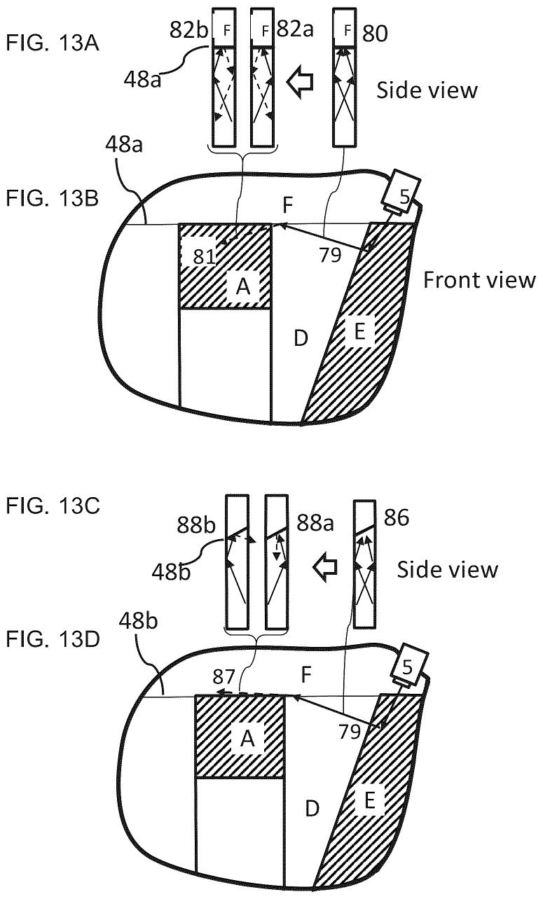

Another type of unwanted ghost image may arise from reflections of the guided image light within the LOE reflecting from the sections interfaces, as will now be discussed with reference to FIGS. 13A and 13B. FIGS. 13A and 13B show side and front views of reflection from a perpendicular interface 48a. FIG. 13A is subdivided into three side views labeled 80, 82a and 82b. Side view 80 shows a beam 79 propagating within the lightguide as two conjugate beams that reflect as TIR from the lightguide faces. Side view 82a and 82b show how each of the conjugate beams reflects from interface 48a to generate ghost 81 (dashed arrows). Both diagrams 82a and 82b show that a full ghost (including both conjugated reflections) propagates into section A and from there the ghost image is reflected towards the eye (not shown).

FIGS. 13C and 13D are similar to FIGS. 13A and 13B, respectively, but illustrate how a tilted interface eliminates this ghost.

FIG. 13C is again subdivided into three views labeled 86, 88a and 88b. Side view 86 shows how beam 79 impinges on tilted facet 48b. In 88a, it is shown how one of the conjugate beams from 79 is reflected at different angle therefor will propagate along the lightguide in a different direction 87 and will not enter section A (or will enter but not be reflected towards the eye). View 88b shows that the other conjugate beam from 79, impinging on 48b at a different angle, may be coupled out of the lightguide, either away from the user or at least outside the eye-box, and therefore will not be observed.

The tilt of interface 48b may be chosen after simulating the propagation of beams (e.g., the two conjugates of beam 79) and is then implemented when processing the interface with section F. The interfaces between other sections may also be processed to be slanted at various angles, depending on an analysis of the predicted ghosts projection, to minimize occurrence of ghosts likely to reach the eye-box.

As discussed above, in cases where a retarder element is to be included between region E and region A, it is often advantageous to orient the retarder at an oblique angle to the major surfaces of the LOE. Clearly, where the interfaces between segments of the LOE are themselves implemented as inclined interface surfaces, this facilitates inclusion of an obliquely inclined retarder element at those interfaces simply by sandwiching the element between the surfaces during assembly. Thus, a retarder element may be included, for example, between segments E and D, or between segments D and A/B, in the configurations illustrated here.

In order to reduce costs of production, it is preferred to stack the section plates and process the interface sections simultaneously. Preparing the plates themselves is known in the art and not described here. FIG. 14A illustrates assembly of multiple plates 92 into a stack 94. The plates are preferably glued with detachable glue, which may be, for example, wax that melts when heated. Soluble interface layers may be introduced between the plates for ease of detachment. The dashed lines represent the designed processing line, which can be processed by grinding or polishing. The processing can be on one side or simultaneous double-sided.

FIG. 14B shows the polished stack 97 from which individual edge-processed plates 98 can then be detached.

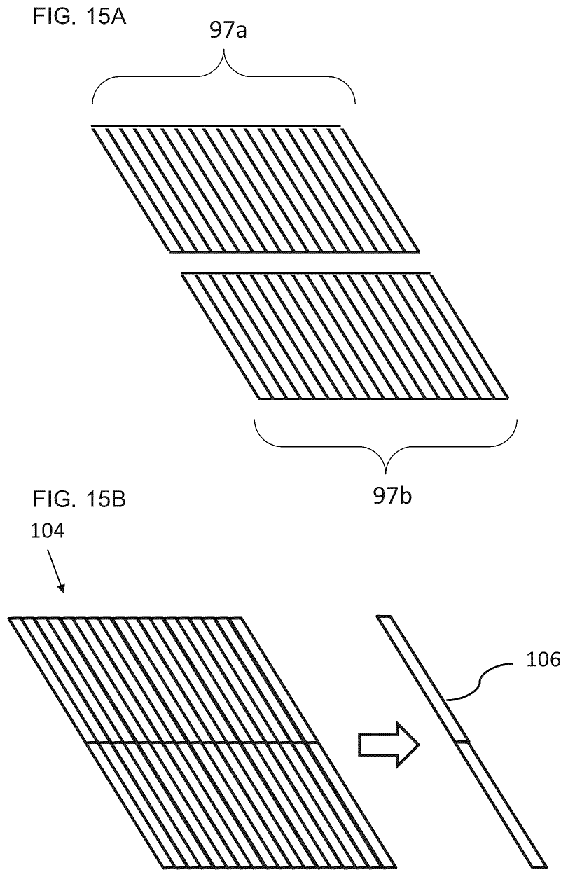

Further cost reduction in sections processing and integration can be achieved by performing the integration while the section plates are stacked. FIGS. 15A and 15B illustrate schematically such a process. In FIG. 15A, two stacks 97a and 97b which have already been processed as described in FIG. 14B are attached with permanent index-matched glue. Combined stack 104 is generated and can be processed on another surface to accept another section-stack. So long as the plates and the stacks have the same thicknesses, this process attaches each plate of one stack to a corresponding plate of the other stack. After eliminating the detachable adhesive, individually combined sections 106 can be separated.

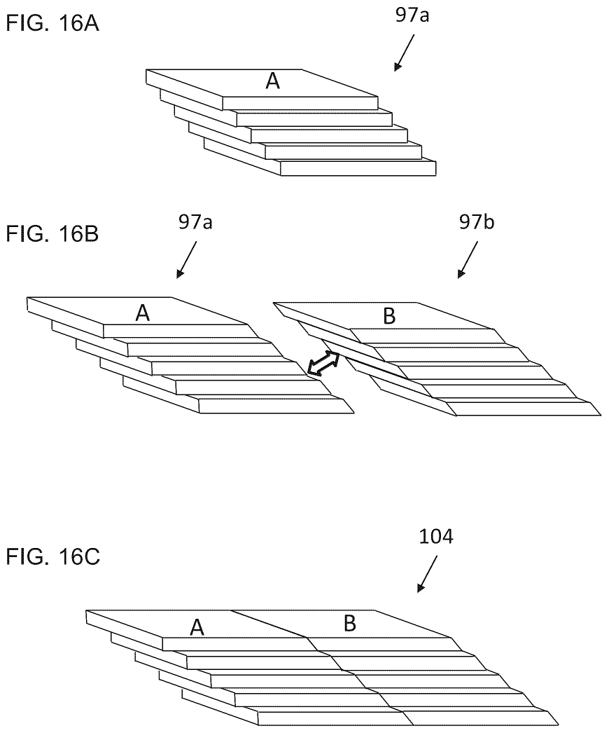

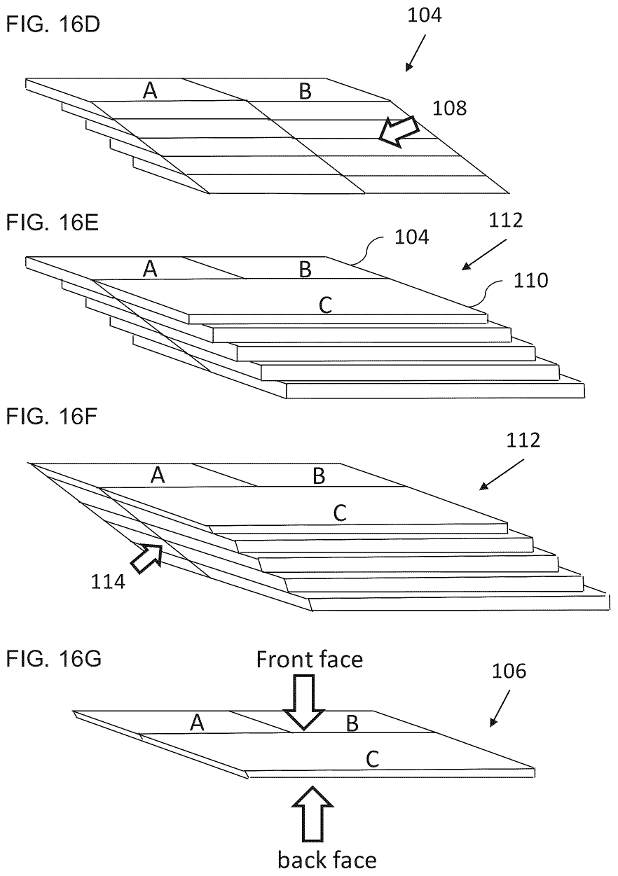

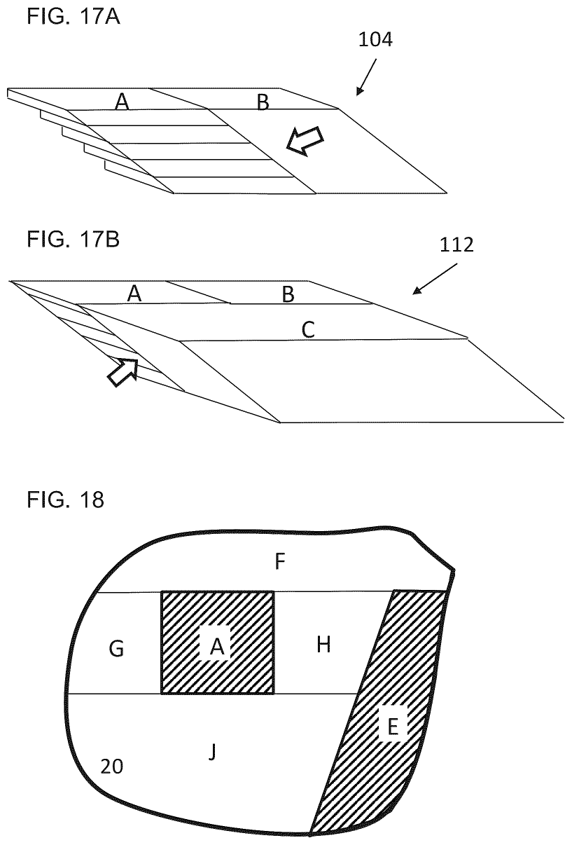

FIGS. 16A-16G show schematic isometric views of the same process representing, for example, part of the process of FIGS. 11A-11E performed as batch processing of multiple LOE segments arranged in a stack. Other arrangements of sections are also possible.

In FIG. 16A, plates of section A are stacked. Stacking is preferably staggered, producing a stepped stack, to minimize material loss during side-surface processing. The staggering is here shown in two directions. In each direction, the offset between successive plates is chosen to approximate the desired interface inclination, i.e., with the offset divided by plate thickness corresponding to the tangent of the inclination angle.

FIG. 16B shows stacks 97a, 97b of segments A and segments B processed at complementary inclination angles ready for bonding (shown as double arrow) to generate the combined stack 104 of segments A and B, as shown in FIG. 16C (equivalent to FIG. 15B). Bonding is performed with permanent adhesive where every plate is adjacent only to the opposing plate. The dissolvable (or otherwise releasable) layers between the plates reduce cross-plates adhesion by the permanent glue.

FIG. 16D illustrates processing of the combined surface 108 of stack 104 of segments A and C (thick arrow). This surface is then glued to a corresponding stack 110 of section C, similarly processed, as shown in FIG. 16E. This is equivalent to the assembly stage of FIG. 11C, but omits sections D and E for clarity.

In FIG. 16F, the combined stack 112 is processed on another surface 114 (thick arrow) in preparation for bonding to a stack of segment F (not shown), equivalent to FIG. 11D. Again, stacks of segments D and E are not shown for simplicity of presentation but can be included through equivalent processing. The staggering orientation and shift of sections F should be same as staggered section A so that, after detachment, the lightguides have the same configuration.

Detaching the connected section-pates (for example by heating the wax-adhesive) delivers the separate lightguides 106 made up of the attached sections, as shown in FIG. 16G, ready for front and back surface polishing (preferably simultaneous double side polishing) and trimming to form the final LOE.

FIGS. 17A and 17B illustrate a variant implementation of this manufacturing process in which the blocks which are to form blank sections of the LOE are not pre-sliced. In FIG. 17A, section B is unsliced but polished at the required angle to mate with the stack of segments A, as in FIGS. 16B and 16C. FIG. 17B shows section C also as an unsliced block, polished at the required angle for bonding to the A/B precursor block 104, equivalent to FIG. 16E. In this configuration, the final combined arrangement (A-F) is sliced to generate the separate lightguides. As before, this process will generate a slanted interface between the blocks (depending on orientation of staggering and polishing).

FIG. 18 illustrates an alternative subdivision of lightguide 20 into segments. All of the above description of the structure, function and manufacturing methods is equally applicable to this configuration and any other alternative configurations.

All the detachable processes referred to above may be performed also by sawing, for example, using a wire saw or disk saw, along the attachment lines. In many lightguide configurations, this sawing need not be accurate since the double-sided polishing of front and back surfaces achieves the required accuracy.

It will be noted that not all of the interfaces need to be inclined at the same angle. In fact, most preferably, the inclination of each interface is chosen according to the features of that specific design in order to minimize the effects of potential image ghosts and/or real-world ghosts reaching the eye-box during typical usage scenarios. Furthermore, some interfaces may be implemented as perpendicular (non-inclined) interfaces.

As mentioned earlier, where a retarder element is required, it may be implemented as an additional layer, either formed directly on one of the polished surfaces of one of the stacks or introduces on a thin carrier plate, at the appropriate interface. The desired inclination angle for the retarder element is taken into consideration in the design of the interface inclination angle.

Thus, in summary, an aspect of the present invention provides a method for manufacturing LOEs having at least a first region and a second region bonded at an obliquely angled interface plane. The method includes forming a first stack of a plurality of LOE first region precursor plates temporarily bonded together at adjacent major surfaces to form bonding planes, and providing a complementary block, which may be a stack of temporarily bonded LOE second region precursor plates, or a unitary block of transparent material, depending on the desired final structure of the LOE. The first stack and the complementary block are both processed to form a smooth edge surface at an oblique angle to the major surfaces, and they are bonded together at these smooth edge surfaces. The resulting composite block is then parted along planes corresponding to the bonding planes to generate a plurality of LOEs having a first region and a second region bonded at an obliquely angled interface plane. The parting process may be a cutting process or, where both components are formed from temporarily bonded stacks of precursor plates, the parting process may be releasing of the temporary adhesive, such as by melting wax or dissolving a soluble adhesive.

To minimize the material which must be removed to form the obliquely-angled smooth edge surfaces, the stacks of plates are preferably bonded together in a stepped configuration with an offset between successive precursor plates chosen to approximate to the required oblique angle.

Where required, a retarder plate may be integrated at the interface plane. Where more complex structures are required, the composite block may be further processed to generate a second smooth edge surface at a second oblique angle, for bonding of a suitably processed second complementary block, and/or additional components, prior to parting the composite structure into individual LOEs.

It will be appreciated that the above descriptions are intended only to serve as examples, and that many other embodiments are possible within the scope of the present invention as defined in the appended claims.

What is claimed is:

1. A method for manufacturing lightguide optical elements (LOEs) having an embedded retarder inclined at an oblique angle, the method comprising the steps of:
(a) forming a first stack of a plurality of planar retarder elements interspaced with, and bonded to, a plurality of transparent plates;
(b) slicing said first stack along a plurality of parallel slicing planes obliquely angled to said planar retarder elements to form at least one tilted retarder plate having a pair of major parallel surfaces and containing portions of a plurality of said planar retarder elements obliquely angled to said major parallel surfaces;
(c) forming a second stack comprising said tilted retarder plate interposed between, and bonded to, a first precursor block and a second precursor block; and
(d) slicing said second stack along a plurality of parallel slicing planes to form a plurality of LOEs each containing part of said tilted retarder plate, thereby providing an obliquely angled embedded retarder in each of said LOEs.

2. The method of claim 1, wherein said slicing planes of said second stack are aligned with said portions of said planar retarder elements so that each of said LOEs contains part of only one of said planar retarder elements.

3. The method of claim 1, wherein said slicing planes of said second stack are aligned with said portions of said planar retarder elements so that at least two of said LOEs contain parts of one of said planar retarder elements.

4. The method of claim 1, wherein said first precursor block comprises a plurality of partially reflecting planar internal surfaces at a first orientation non-parallel to said planar retarder elements and said second precursor block comprises a plurality of partially reflecting planar internal surfaces at a second orientation non-parallel to both said planar retarder elements and said first orientation.

5. The method of claim 1, wherein said first precursor block comprises a plurality of LOE precursor portions temporarily bonded together at bonding planes to form a block, and wherein said slicing of said second stack is performed along said bonding planes.

6. A method for manufacturing lightguide optical elements (LOEs) having a first region and a second region bonded at an obliquely angled interface plane, the method comprising the steps of:
(a) forming a first stack of a plurality of LOE first region precursor plates, each precursor plate having two mutually parallel major surfaces, each precursor plates being temporarily bonded together at adjacent major surfaces to form bonding planes;
(b) processing said first stack to form a smooth edge surface at an oblique angle to said major surfaces;
(c) processing a complementary block having outer surfaces to form a smooth edge surface at said oblique angle to said outer surfaces;
(d) bonding said smooth edge surface of said first stack to said smooth edge surface of said complementary block at an interface plane to form a composite block; and
(e) parting said composite block along planes corresponding to said bonding planes to generate a plurality of LOEs having a first region and a second region bonded at an obliquely angled interface plane.

7. The method of claim 6, wherein said first region precursor plates are temporarily bonded together in a stepped configuration with an offset between successive precursor plates, said stepped configuration approximating to said oblique angle.

8. The method of claim 6, wherein said bonding includes integrating a retarder plate at said interface plane.

9. The method of claim 6, wherein said complementary block is a second stack of a plurality of LOE second region precursor plates, each precursor plate having two mutually parallel major surfaces, said precursor plates being temporarily bonded together at adjacent major surfaces to form bonding planes.

10. The method of claim 6, wherein said complementary block is a unitary block of transparent material.

11. The method of claim 6, wherein said first stack and said complementary block are each further processed to generate a second smooth edge surface at a second oblique angle, the method further comprising the steps of:
(a) processing a second complementary block having outer surfaces to form a smooth edge surface at said second oblique angle to said outer surfaces;
(b) bonding said second smooth edge surfaces of said first stack and said complementary block to said smooth edge surface of said second complementary block at a second interface plane to form said composite block prior to said parting.
